(19) United States
(12) Patent Application Publication
(10) Pub. No.: US 2009/0164316 A1
(43) Pub. Date: Jun. 25, 2009

(54) System and Method for Search, Recommendation, and Advertisement Through a Unified Storefront

(75) Inventors: David Piepenbrink, Chicago, IL (US); Leonardo Velazquez, Plano, IL (US); Lee Chow, Naperville, IL (US); Sudha Gopal, Plano, TX (US); Helen Ly, Alameda, CA (US)

Correspondence Address: AT&T Legal Department - LNAP;Attn: Patent Docketing, Room 2A- 207, One AT & T Way, Bedminster, NJ, 07921, US

(73) Assignee: AT&T KNOWLEDGE VENTURES, LP, Reno, NV (US)

(21) Appl. No.: 11/963,923

(22) Filed: Dec. 24, 2007

(51) Int. Cl. G06Q 30/00

(52) U.S. Cl. 705/14; 705/1; 705/26

(57) ABSTRACT

A system includes an asset database, a search engine, a recommendation engine, and an advertisement module. The search engine is adapted to search for a first asset, stored in the asset database, based on a metadata search inquiry received from one of a plurality of access devices. The recommendation engine is adapted to recommend a second asset based on the metadata search inquiry, adapted to recommend a third asset based on customer usage information, and adapted to recommend the second asset and the third asset also based on an access device in communication with the recommendation engine. The advertisement module is adapted to provide an asset advertisement based upon the customer usage information and one of the asset categories being searched. Methods for searching, recommending, advertising assets to the plurality of access devices are also disclosed.

### FIELD OF THE DISCLOSURE

The present disclosure generally relates to communications networks, and more particularly relates to a unified storefront.

### BACKGROUND

Individuals can access online databases to purchase a variety of products. Some products, however, are accessible only through a particular device. Currently, the products available for purchase are located in different online databases, requiring the customer to use a plurality of devices to access, search, and purchase products associated with the various devices. For example, a set-top box may be used to purchase a video-on-demand, and a cellular telephone may be used to purchase a ring tone. Thus, the customer must use one device to purchase certain products associated with that device, and use a second device if the customer wishes to purchase certain products associated with the second device. While using the different devices the customer is also provided with recommendations and advertisements for different products.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an embodiment of a portion of an unified storefront system;

FIG. 2 is a block diagram illustrating a recommendation portion of the unified storefront system in greater detail;

FIG. 3 is a flow diagram of a method for providing a metadata search inquiry to a plurality of access devices;

FIG. 4 is a flow diagram of a method for displaying advertisements in the unified storefront system of FIG. 1;

FIG. 5 is a flow diagram of a method for displaying recommendations based on customer profile information in the unified storefront system of FIG. 1; and

FIG. 6 is a flow diagram of a method for displaying recommendations based on a search inquiry received in the unified storefront system of FIG. 1.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

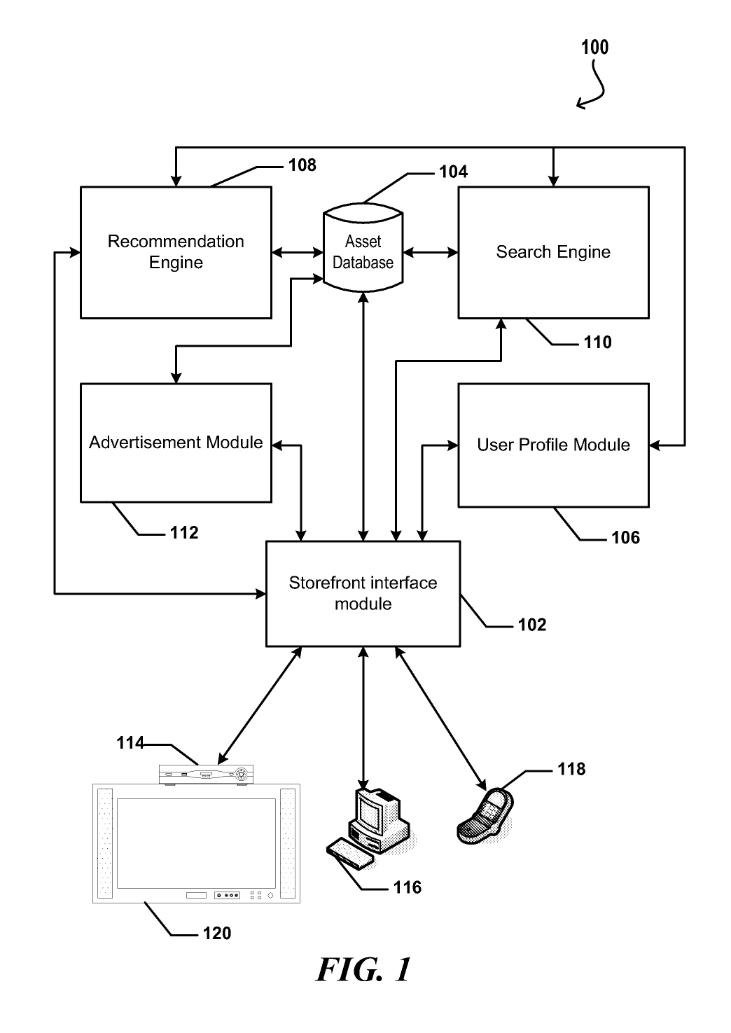

FIG. 1 shows a unified storefront system 100 including a storefront interface module 102, a recommendation engine 108, and a search engine 110. The unified storefront system 100 also includes an advertisement module 112, an asset database 104, and a user profile module 106. The storefront interface module 102 is in communication with the recommendation engine 108, the search engine 110, the advertisement module 112, the asset database 104, and the user profile module 106. Additionally, the recommendation engine 108 is in communication with the search engine 110, the asset database 104, and the user profile module 106, while the search engine 110 and the advertisement module 112 are both in communication with the asset database 104.

The storefront interface module 102 can provide the user of the set-top box 114, the computer 116, or the cellular telephone 118 with access to the unified IPTV system 100. The storefront interface module 102 preferably accomplishes this by presenting the user with a graphical user interface (GUI) for navigation on a display device associated with the access device, such as the television 120 when the access device is the set-top box 114. The user can use the GUI to browse the unified storefront system 100 or to enter search inquiries for specific assets available for purchase and stored in the asset database 104.

The asset database 104 stores videos-on-demand, digital songs, digital video disc (DVD) movies, compact disc (CD) music, cellular telephone wallpapers, ringtones, applications, games, and the like as physical and digital assets available for purchase by the user of the unified storefront system 100. The different assets can be divided into different asset categories, such as movies, music, and the like and each category can include multiple assets. For example, the asset category for movies can include videos-on-demand, DVDs, and the like.

As the user navigates through the unified storefront system 100, the user profile module 106 can store browsing, searching, purchasing history, post purchasing events, and information identifying the access device used to connect with the unified storefront system for the user as a customer profile. The user profile module 106 can update the customer profile every time the user accesses the unified storefront system 100 with any one of the access devices. Thus, the customer profile information can be complied for the user from multiple access devices, such as the set-top box 114, the computer 116, and the cellular telephone 118. The information obtained for a given user is utilized by the other components in the unified storefront system 100.

For example, the recommendation engine 108 utilizes the customer profile stored in the customer profile module 106 to aid the recommendation of assets to the user. The recommendation engine 108 can use the customer profile to determine what asset or assets the user typically browses for, searches for, or purchases and recommend physical and digital assets based on the customer profile complied from the usage on all of the access devices. Thus, based on the customer profile, the recommendation engine 108 determines assets in which the user would have interest, and recommends these assets to the user. The recommendation engine 108 can also use the access device currently being used to access the unified storefront system 100 to recommend physical and digital assets associated with that particular access device. The recommendation engine 108 can also select and recommend assets based on the search inquiry provided through the storefront interface module 102. Thus, the recommendation engine 108 can use search terms from the search inquiry in determining which assets to recommend to the user.

The search engine 110 can provide an in-depth metadata search inquiry for assets offered to the user through the unified storefront system 100. The user can search for assets using any combination of search criteria, such as title, name, keyword, movie lines, dialog, song lyrics, rating, genre, and the like. The search engine 110 provides the user with the capability to search, using any one of the access devices, all of the asset categories offered by the unified storefront system 100 and stored in the asset database 104. For example, the user can view and purchase ring tones, DVDs, and videos-on-demand while accessing the unified storefront system 100 with the set-top box 114. Thus, the search engine 110 can return the same search results, for the same search inquiry, to any of the access devices regardless what access device the asset is associated with.

While searching for an asset, the user can select a specific asset category to search, such as video-on-demand, or search all the asset categories. Upon receiving the search inquiry, the search engine 110 searches the asset database 104 to determine which assets, if any, match the search inquiry. If one or more assets match the search inquiry, the search engine 110 sends the assets to the storefront interface module 102 to be displayed to the user on the GUI of the storefront interface module 102. The user can be given the opportunity to purchase any of the assets returned during the search inquiry regardless of whether the asset is associated with the access device. For example, the user can purchase a video-on-demand during a search inquiry performed with the cellular telephone 118. The recommendation engine 108 and the search engine 110 can respectively provide recommendations and search results to the user at the same time.

The advertisement module 112 can provide the user with actionable and non-actionable advertisements. Actionable advertisement can provide the user with the opportunity to view additional information about the advertisement, such as the option purchase the asset advertised. The advertisement module 112 can base the advertisement on the customer profile information while the user is accessing the unified storefront system 100 via one of the access devices. As the user browses through the different asset categories in the unified storefront system 100, different actionable and non-actionable advertisements can be displayed at various times. Depending on the criteria used by the advertisement module 112, the same advertisements may be returned to the user while accessing the unified storefront system 100 through the set-top box 114, the computer 116, and the cellular telephone 118.

The advertisement module 112 can also cross-promote asset categories, such that if the user is browsing or searching within a specific asset category the advertisement module can return an advertisement for a similar asset found in a different asset category. For example, if the user is browsing or searching for DVDs of a certain genre, the advertisement module 112 can display an advertisement for a video-on-demand within the same genre. Additionally, the advertisement module 112 can advertise assets associated with an access device other than the access device currently being used by the user to access the unified storefront system 100.

When accessing the unified storefront system 100 with the set-top box 114 or the cellular telephone 118 and upon selecting an advertisement, the display of the GUI provided by the storefront interface module 102 can be changed to give the user the ability to purchase the asset. However, if the user selects an advertisement, by clicking an actionable advertisement, while accessing the unified storefront system 100 with the computer 116, the current display window in the graphical user interface remains the same, and a new window is opened to provide the user with the ability to view more information about the advertisement. The advertisement module 112 receives all the necessary information about the asset, such as the metadata stored in the asset database 104, prior to selecting an advertisement to display to the user. Therefore, the advertisement module 112 can perform a detailed analysis of the assets before an advertisement is selected, so that the asset advertised on the GUI to the user will be of interested to the user.

The unified storefront system 100 can provide the user with the ability from each of the access devices to view and purchase the assets stored in the asset database. The user can utilize the GUI to browse the unified storefront system 100 or search for specific assets. The recommendation engine 108 and the advertisement engine 112 can also present the user with assets that are associated with an access device other than the current access device being used. Thus, the unified storefront system 100 can provide the user with the ability to purchase any asset stored in the asset database 104 through any one of the access devices. For example, the user can search and purchase a video-on-demand asset, which is typically associated with the set-top box 114, by accessing the unified storefront system 100 via the set-top box, the computer 116 or the cellular telephone 118.

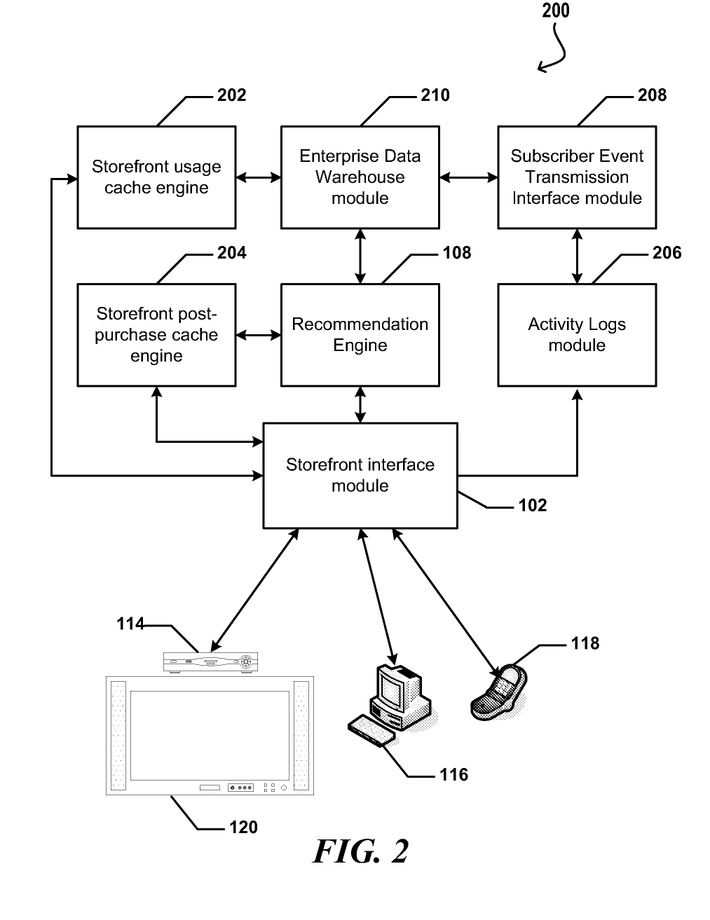

FIG. 2 shows an embodiment of a recommendation portion 200 of the unified storefront system 100. The recommendation portion 200 includes the storefront interface module 102, the recommendation engine 108, a storefront usage cache engine 202, and a storefront post-purchase cache engine 204. The recommendation portion 200 also includes an activity log module 206, a subscriber event transmission interface (SETI) module 208, and an enterprise data warehouse (EDW) module 210. The storefront interface module 102 is in communication with the recommendation engine 108, the storefront usage cache engine 202, the storefront post-purchase cache engine 204, and the activity log module 206. The recommendation engine 108 is in communication with the storefront post-purchase cache engine 204 and the EDW module 210. The storefront usage cache engine 202 is in communication with the EDW module 210. The activity log module 206 is in communication with the SETI module 208, which is in communication with the EDW module 210.

The storefront usage cache engine 202 can store customer usage and information about the different assets viewed by the user while accessing the unified storefront system 100. The information stored by the storefront usage cache engine 202 can include the number of times the asset is viewed by the user, the access device used to view the asset, whether the asset has been purchased by the user, whether the user viewed the asset while browsing, searching, and the like. The storefront usage cache engine 202 can also send the customer usage and asset information to the EDW module 210.

The storefront post-purchase cache engine 204 can capture and store the customer usage information after the user purchases an asset in the unified storefront system 100 with the set-top box 114, the computer 116, or the cellular telephone 118. The customer usage information stored by storefront post-purchase cache engine 204 can be used to determine whether the user continues to browse or search for asset within the same asset category, whether the user views another asset category, and the like. The storefront post-purchase cache engine 204 can send the customer usage information to the recommendation engine 108.

The activity log module 206 can capture the post purchase activities for the user while accessing the unified storefront system 100 with the set-top box 114. The activity log module 206 can send the stored activities to the SETI module 208, which compiles the activities each time the set-top box 114 is used. The SETI module 208 can also send the stored activities to the EDW module 210. In an embodiment, the information stored in the activity log module 206 can also be extracted and sent to the EDW module 210 by any additional module or process with or without the SETI module 208.

The EDW module 210 can compile and store the customer usage and asset information received from the storefront usage cache engine and the SETI module 208. Additionally, the EDW module 210 can send the stored information to the recommendation engine 108 to allow the recommendation engine to utilize the customer usage both before and after purchasing an asset when providing a recommendation to the user. Customer usage information provided by the EDW module 210 to the recommendation engine 108 can include user purchase history, user rating information, customer usage history, and the like. The EDW module 210 can additionally provide the recommendation engine 108 with overall community purchase history, overall community rating information, overall community usage history, and the like. The community information can include additional users within a single video hub office (VHO) associated with the access device. The unified storefront system 100 can receive the community information from the VHO and provide the information to the recommendation engine 108 for recommending assets to the user.

The recommendation engine 108 can provide recommendations for multiple asset categories when the user is browsing or searching assets without having first selected a specific asset category, such as videos-on-demand. Upon the user selecting a specific asset or performing a search within an asset category, the recommendation engine 108 can provide asset level recommendations, such as recommendations for assets within the category currently being viewed by the user. Prior to purchasing an asset, the recommendation engine 108 can include the asset currently being viewed by the user in the recommended assets. Post purchasing, the recommendation engine 108 preferably removes the purchased asset from the recommended assets before displaying the recommendations to the user.

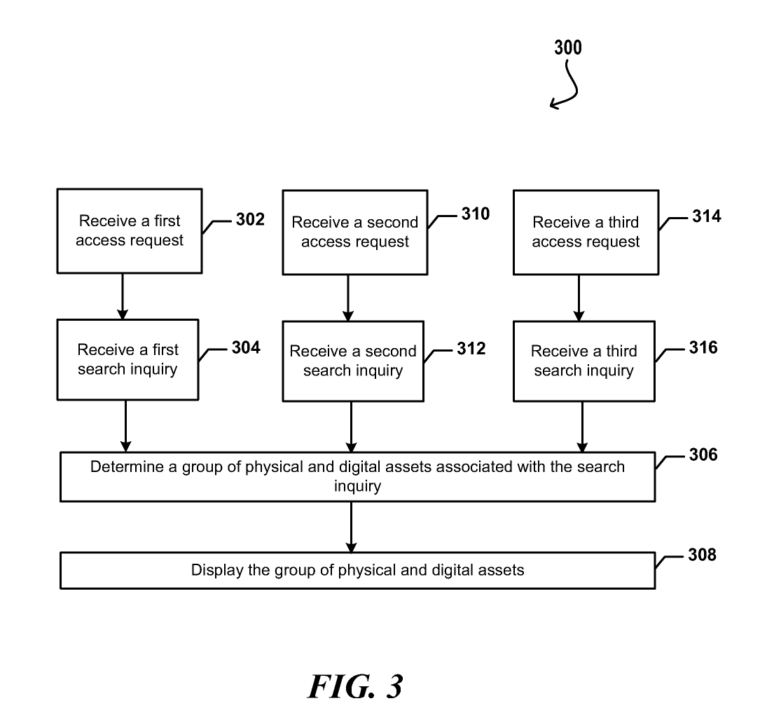

FIG. 3 shows a flow diagram of an exemplary method 300 for providing a metadata search inquiry to multiple access devices. At block 302, a first access request is received from one of the access devices. The access device can be the set-top box, the computer, or the cellular telephone. At block 304, a first search inquiry is received. The search inquiry can include metadata information, such as title, name, movie lines, song lyrics, keywords, genre, and the like. At block 306, a group of physical and digital assets associated with the search inquiry is determined. The group of physical and digital assets can include multiple asset categories or a single asset category depending on the search inquiry. The asset categories can include videos-on-demand, digital song downloads, digital video disc (DVD) movies, compact disc (CD) music, and the like. At block 308, the group of physical and digital assets is displayed to the access device.

At block 310, a second access request is received from one of the access devices. At block 312, a second search inquiry is received. Upon receiving the second search inquiry, a group of physical and digital assets associated with the search inquiry is determined at block 306. If the second search inquiry is the same as the first search inquiry, then the same group of physical and digital assets can be selected. At block 308, the group of physical and digital assets associated with the second search inquiry is displayed.

At block 314, a third access request is received from one of the access devices. At block 316, a third search inquiry is received. Upon receiving the third search inquiry, a group of physical and digital assets associated with the search inquiry is determined at block 306. If the third search inquiry is the same as the first and second search inquiries, then the same group of physical and digital assets can be selected. If the third search inquiry is not the same as the first and second search inquiries, then a different group of physical and digital assets can be selected. At block 308, the group of physical and digital assets associated with the third search inquiry is displayed.

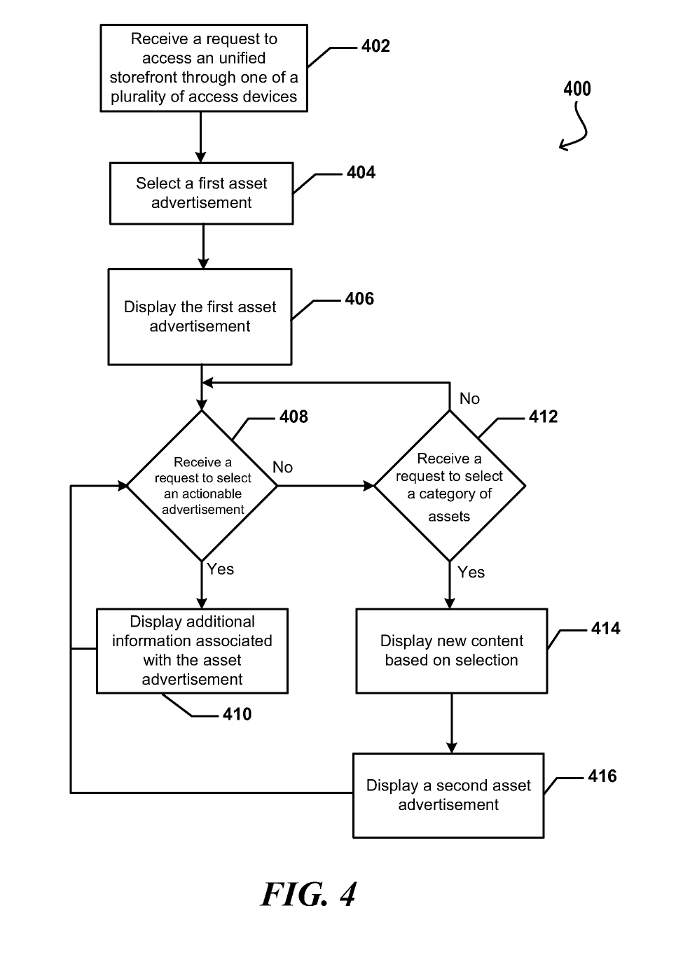

FIG. 4 shows a flow diagram of an exemplary method 400 for displaying advertisements in the unified storefront system. At block 402, a request to access the unified storefront system is received from one of a plurality of access devices. A first asset advertisement is selected at block 404. At block 406, the first asset advertisement is displayed to the access device. The first asset advertisement may be an actionable advertisement or a non-actionable advertisement. At block 408, a determination is made whether an actionable advertisement is selected. If the actionable advertisement is selected, additional information associated with the asset advertisement is displayed at block 410. The additional information can include the option to purchase the advertised asset. At block 412, if the actionable advertisement is not selected, a determination is made whether a category of assets is selected. If an asset category is not selected, the flow diagram continues as described above at block 408. However, if an asset category is selected, new content based on the selection is displayed at block 414. At block 414, a second asset advertisement is displayed and then the flow diagram continues as stated above at block 408.

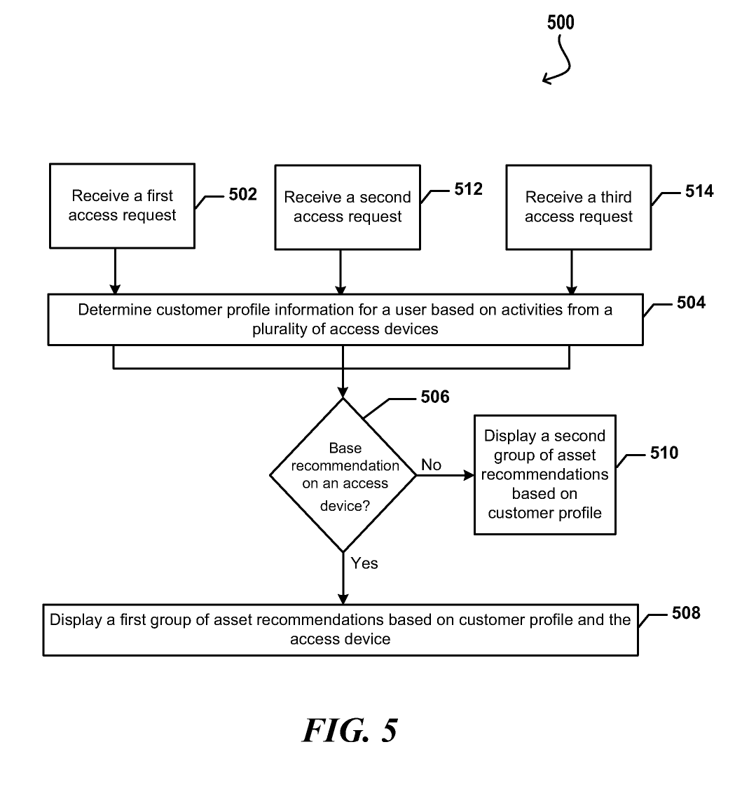

FIG. 5 shows a flow diagram of an exemplary method 500 for displaying recommendations based on customer profile information in the unified storefront system. At block 502, a first access request is received from one of multiple access devices. At block 504, customer profile information for a user is determined. The customer profile information can include browsing, searching, purchasing history, post purchasing events, and information identifying the access device used to connect with the unified storefront system. The customer profile information can also be complied for the user from multiple access devices, such as the set-top box, the computer, and the cellular telephone. At block 506, a determination is made whether or not to also base the recommendation on the access device. At block 508, if the recommendation is also based on the access device, then a first group of asset recommendations based on the customer profile information and on the access device is displayed. If the recommendation is not also based on the access device, then a second group of asset recommendations based only on the customer profile information is displayed at block 510.

At block 512, a second access request is received from one of the access devices. At block 504, customer profile information for a user is determined. At block 506, a determination is made whether or not to also base the recommendation on the access device. At block 508, if the recommendation is also based on the access device, then a third group of asset recommendations based on the customer profile information and on the access device is displayed. If the second access device is the same as the first access device the same group of asset recommendations can be displayed. If the recommendation is not also based on the access device, then a fourth group of asset recommendations based only on the customer profile information is displayed at block 510. If the user is the same for the second access request as the first access request then the fourth group of asset recommendations can be the same as the second group of asset recommendations.

At block 512, a third access request is received from one of the access devices. At block 504, customer profile information for the user is determined. At block 506, a determination is made whether or not to also base the recommendation on the access device. At block 508, if the recommendation is also based on the access device, then a fifth group of asset recommendations based on the customer profile information and on the access device is displayed. If the third access device is the same as the first or second access devices the same group of asset recommendations can be displayed. If the recommendation is not also based on the access device, then a sixth group of asset recommendations based only on the customer profile information is displayed at block 510. If the user is the same for the third access request as the first or second access requests then the sixth group of asset recommendations can be the same as the second or fourth group of asset recommendations.

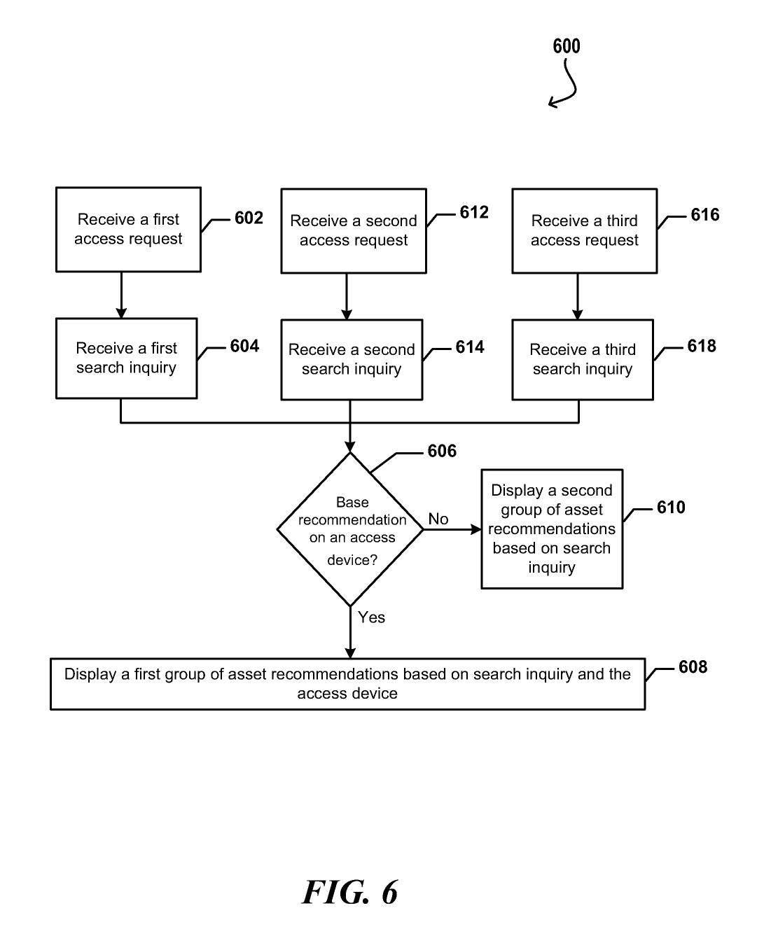

FIG. 6 shows a flow diagram for an exemplary method 600 for displaying recommendations based on a search inquiry received in the unified storefront system. At block 602, a first access request is received from one of multiple access devices. At block 604, a first search inquiry is received. The search inquiry can include metadata information, such as title, name, movie lines, song lyrics, keywords, genre, and the like. At block 606, a determination is made whether to also base an asset recommendation on the access device. At block 608, if the recommendation is also based on the access device, then a first group of asset recommendations based on the search inquiry and on the access device is displayed. If the recommendation is not also based on the access device, then a second group of asset recommendations based only on the search inquiry is displayed at block 610.

At block 612, a second access request is received from one of the access devices. At block 614, a second search inquiry is received. At block 606, a determination is made whether to also base an asset recommendation on the access device. At block 608, if the recommendation is also based on the access device, then a third group of asset recommendations based on the search inquiry and on the access device is displayed. If the second access device is the same as the first access device the same group of asset recommendations can be displayed. If the recommendation is not also based on the access device, then a fourth group of asset recommendations based only on the search inquiry is displayed at block 610. If the user is the same for the second access request as the first access request then the fourth group of asset recommendations can be the same as the second group of asset recommendations.

At block 614, a third access request is received from one of the access devices. At block 616, a third search inquiry is received. At block 606, a determination is made whether or not to also base the recommendation on the access device. At block 608, if the recommendation is also based on the access device, then a fifth group of asset recommendations based on the customer profile information and on the access device is displayed. If the third access device is the same as the first or second access devices the same group of asset recommendations can be displayed. If the recommendation is not also based on the access device, then a sixth group of asset recommendations based only on the customer profile information is displayed at block 510. If the user is the same for the third access request as the first or second access requests then the sixth group of asset recommendations can be the same as the second or fourth group of asset recommendations.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGs. are to be regarded as illustrative rather than restrictive.

The Abstract of the Disclosure is provided to comply with 37 C.F.R. §1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A system comprising:
an asset database having a plurality of assets, each asset associated with a plurality of asset categories and with one of a plurality of access devices;
a search engine in communication with the asset database, the search engine adapted to search for a first asset included in the plurality of assets based on a metadata search inquiry received from an access device of the plurality of access devices, and adapted to display a search result on a graphical user interface;
a recommendation engine in communication with the asset database, the recommendation engine adapted to recommend a second asset included in the plurality of assets based on the metadata search inquiry, adapted to recommend a third asset based on customer usage information, adapted to recommend the second asset and the third asset also based on the access device of the plurality of access devices in communication with the recommendation engine, and adapted to display the second and third assets on the graphical user interface; and
an advertisement module in communication with the asset database, the advertisement module adapted to provide an asset advertisement based upon the customer usage information and one of the asset categories being searched by the search engine, and adapted to display the asset advertisement on the graphical user interface.

2. The system of claim 1 wherein the search engine is further adapted to display a first plurality of assets based on the metadata search inquiry to the access device of the plurality of access devices.

3. The system of claim 1 wherein the metadata inquiry is selected from the group consisting of a title, a name, a keyword, a movie line, a song lyric, a rating, and a genre.

4. The system of claim 1 wherein the plurality of access devices includes an Internet Protocol television receiver, a mobile device, and a computer.

5. The system of claim 1 wherein the customer usage information is complied from the plurality of access devices.

6. The system of claim 1 wherein the plurality of assets include a digital song, a compact disc, a video on-demand program, and a digital video disc.

7. The system of claim 1 wherein the asset advertisement is an actionable advertisement.

8. The system of claim 1 further comprising:
a storefront interface module in communication with the asset database, the storefront interface module adapted to output to the access device of the plurality of access devices a plurality of asset information received from the asset database, the search engine, the recommendation engine, and the advertisement module.

9. A system comprising:
an asset database having a plurality of assets, each asset associated with a plurality of asset categories and with one of a plurality of access devices; and
a recommendation engine in communication with the asset database, the recommendation engine adapted to suggest a first asset included in the plurality of assets based on a first access device of the plurality of access devices and based on a metadata search inquiry received from the first access device, and adapted to display the first asset on a graphical user interface.

10. The system of claim 9 further comprising:
a search engine in communication with the asset database, the search engine adapted to search for a second asset included in the plurality of assets based on the metadata search inquiry and to display a search result on the graphical user interface.

11. The system of claim 9 further comprising:
a storefront interface module in communication with the asset database, the storefront interface module adapted to allow the first access device of the plurality of access devices to connect with the asset database, the search engine, and the recommendation engine.

12. The system of claim 9 wherein the recommendation engine is further adapted to recommend a second asset associated with a second access device of the plurality of access devices to the first access device of the plurality of access devices based on the metadata search inquiry.

13. A method comprising:
receiving a first search inquiry for a first asset stored in an asset database, the first asset being included in a plurality of asset categories and each asset category being associated with a different access device;
determining a first access device from which the first search inquiry is received, the first access device included in a plurality of access devices; and
displaying a first plurality of assets based on the first search inquiry and based on the first access device, the first plurality of assets capable of being purchased with the first access device.

14. The method of claim 13 wherein the first of the plurality of assets is selected from the group consisting of a digital song, a compact disc, a video on-demand program, and a digital video disc.

15. The method of claim 13 further comprising:
receiving a second search inquiry for a second asset stored in the asset database, the second asset being included in the plurality of asset categories;
determining a second access device from which the second search inquiry is received, the second access device included in the plurality of access devices; and
displaying a second plurality of assets based on the second search inquiry and based on the second access device, the second plurality of asset capable of being purchased with the second access device.

16. The method of claim 15 wherein the second plurality of assets is the same as the first plurality of assets.

17. The method of claim 13 wherein the first search inquiry is a metadata search inquiry.

18. The method of claim 13 wherein the first access device is selected from the group consisting of an set-top box, a cellular telephone, and a computer.

19. A method comprising:
determining a first access device for an unified storefront, the first access device being included in a plurality of access devices;
determining a first recommendation from a plurality of assets available for purchase, the first recommendation being based on the first access device and based on customer usage information complied for a user of the plurality of access devices; and
displaying the first recommendation.

20. The method of claim 19 wherein the customer usage information is stored as a customer profile.

21. The method of claim 19 wherein the first access device is selected from the group consisting of an set-top box, a cellular telephone, and a computer.

22. The method of claim 19 further comprising:
determining a second access device for an unified storefront, the second access device being included in the plurality of access devices and being different than the first access device;
determining a second recommendation from the plurality of assets available for purchase based on the second access device and based on the customer usage information complied for the user of the plurality of access devices; and
displaying the second recommendation.

23. A method comprising:
receiving a request to access an unified storefront from a first access device, the first access device being included in a plurality of access devices;
selecting a first asset advertisement for a first asset associated with the plurality of access devices based on the first access device and based on a customer profile; and
displaying the first asset advertisement.

24. The method of claim 23 wherein the first asset advertisement is an actionable advertisement.

25. The method of claim 23 further comprising:
receiving a view request to display an asset category in the unified storefront from the first access device;
selecting a second asset advertisement for a second asset associated with the plurality of access devices based on the asset category and based on the customer profile; and
displaying the second asset advertisement.
